(19) United States
(12) Patent Application Publication
(10) Pub. No.: US 2006/0168511 A1
(43) Pub. Date: Jul. 27, 2006

(54) Method of passing information from a preprocessor to a parser

(75) Inventors: Daniel N. Bauer, Zurich (CH); Andreas Kind, Kilchberg (CH); Jan Van Lunteren, Gattikon (CH)

Correspondence Address: Gail Zarick;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 11/040,776

(22) Filed: Jan. 21, 2005

(51) Int. Cl. G06F 17/21

(52) U.S. Cl. 715/513

(57) ABSTRACT

An apparatus and method suitable for processing an XML document. The method comprises the steps of providing, to a processor, information relating to the structure of the XML document; and providing, to the processor, information obtained by preprocessing the XML document. The apparatus comprises a preprocessor and a processor/parser for performing the method steps.

### BACKGROUND OF THE INVENTION

The present invention relates to processing of structured information, and more particularly to a system and method for processing documents produced in markup language.

The Extensible Markup Language (XML) is a meta-language that provides way to describe or “mark up” the content of a document or data. XML plays an increasingly important role in the exchange of a wide variety of data on the Internet. Because XML can be used to create documents with self-describing data, it simplifies data interchange and enables better search capabilities on the Internet. The XML format is defined in technical specifications developed by the World Wide Web Consortium (W3C) and is published on their web site, http://www.w3.org. W3C® is a trademark (registered in numerous countries) of the World Wide Web Consortium; marks of W3C are registered and held by its host institutions MIT, ERCIM, and Keio.

### BRIEF SUMMARY OF THE INVENTION

XML enables code to be written so that XML documents may be processed without human intervention. Within an XML document, code can be structured to identify specific items of information. Thus, for example, an XML document may be written to automatically extract this structured information from another XML document. Applications based on XML make use of a parser function to process XML-based information. XML processing (which includes parsing), however, is a “compute intensive” task which uses up many processor cycles, thus reducing efficiency and performance.

Accordingly, there is a need for a method of overcoming the inefficiencies associated with processing of documents in markup languages.

We now disclose embodiments of an inventive method and apparatus that accelerates the processing of XML documents by providing a preprocessor that extracts information pertaining to the document structure and possibly other meta-information from an XML document, and/or performs a subset of the XML parsing/processing operation. An XML processor parses the XML document and achieves enhanced performance by using information about the document structure for the parsing and/or information related to the processing already performed by the XML preprocessor. Preferably, an application that uses the standardized XML processing APIs may access the content of the XML document.

According to a preferred embodiment, the invention comprises a computer-implemented method for processing an XML document, comprising:

providing, to a processor, information relating to the structure of the XML document; and

providing, to the processor, information obtained by preprocessing the XML document.

The information relating to the structure of the XML document may be associated with the XML document and/or may be embedded in the XML document. For example, the structure information may be included in an external file such as another XML document, and/or it may be included in a protocol header of a protocol data unit. Alternatively, the structure information may be embedded as a comment in the XML document. The information relating to the structure of the XML document may comprise at least one offset of at least one element in the XML document, such as, for example, byte/character offsets for various elements (e.g., tags, attributes, attribute values, etc.) in the XML document.

The information relating to the structure of the XML document may be retrieved from memory. For example, the information may be stored in one or more hardware register or sets of hardware registers. Alternatively, the information may be stored in a dedicated memory segment. Preferably, the XML document contains a reference to the storage location or file where the structural information is stored.

Preferably, the information obtained by preprocessing the XML document comprises information indicating processing and corresponding results that have been performed for at least one element in the XML document. For example, the processing information may indicate that well-formedness checks have been performed over part or all of the XML document.

The information relating to the structure of the XML document may be used to accelerate a subsequent DTD or Schema check by a validating parser. Such information may comprise: the number of times a first element in the XML document occurs as a child of a second element in the XML document; or a type description of at least one element in the XML document; or a token table of the parsed XML document.

The method may provide, to the parser, information pertaining to partial processing of the XML document in response to preprocessing a portion of the XML document by the preprocessor.

In other aspects, the invention may be a computer program device readable by a machine, tangibly embodying a program of instructions executable by a machine to perform method steps as described herein.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawing, wherein:

FIG. 1 illustrates schematically the architecture of a parsing system in which a preferred embodiment of the present invention may be implemented.

### DETAILED DESCRIPTION OF THE INVENTION

Preliminarily, some of the functions of a parser will be explained to aid in describing the invention. Here, a parser refers to computer code that converts an XML document into a format usable by an application program, or to a computer system or processor which executes the foregoing conversion processing. A parser comprises code that validates a document by trying to read the document and interpret its contents. A web browser, for example, may contain an XML parser. This parser reads XML code and processes and validates the data. From this point, the data may be used by other applications or objects for further processing.

More specifically, an XML parser must perform certain tests in order to determine whether an XML document is well-formed and/or valid, as will be explained below. An additional, basic task of a parser, which is related to the above, is to convert a stream of characters, as these occur in an XML document, into tokens representing tags, attribute names, etc.

The structure of XML documents must follow certain rules. In this respect, three “kinds” of XML documents can be distinguished: (1) well-formed; (2) valid; and (3) non-well-formed.

Well-formed XML documents are documents that follow the syntax rules that have been defined by the XML specification.

Valid XML documents are well-formed XML documents that also follow additional, more complex constraints that are specified in a Document Type Definition (DTD) or by an XML Schema. A DTD is a set of rules that a document follows, i.e., a DTD defines the document structure with a list of elements that are defined for the XML document. Similarly, XML Schemas express shared vocabularies and allow machines (e.g., computers) to carry out rules defined by people. These rules are expressed by the definitional statements within the XML Schema or DTD. Thus, well-formed XML may be designed for use without a DTD or XML Schema, whereas valid XML requires a DTD or XML Schema.

Non-well-formed documents are those that do not follow the syntax rules of XML. Non-well-formed documents are also documents that are not valid.

All XML parsers have to check if XML documents are well-formed and determine whether there are errors in the XML documents. The XML specification requires a parser to reject any XML document that does not follow the basic rules. So called validating parsers also have to check if XML documents are valid. The validation process involves comparing an XML document and a DTD to be sure the XML document is structured correctly and all tags are used in the proper manner. Thus, a parser is a helpful tool for determining why an XML document is not being read properly. A parser may also be used while an XML document is being created to ensure that it is being created correctly.

Non-well-formed documents are rejected by all XML parsers. Invalid documents are rejected by validating parsers. As such, in order for a browser to process an XML document, the XML document must be well formed and valid. Therefore, a precise way to check the well-formedness and validity of a valid XML document is to use a parser to check for errors in XML documents.

To illustrate a few of these rules, the following very simple example of an XML document will be used:

<?xml version =“1.0”?>
<!-- comment A -->
<xdoc>

<greeting>Hello XML!</greeting>
<!-- comment B -->
<hallo><morgen></morgen></hallo>

</xdoc>

According to well-formedness rules, an XML document must have matching start and end tags (e.g., <greeting> and </greeting>), which have to be correctly “balanced” as shown in the example (i.e., overlaps are not allowed). A DTD or XML Schema may impose additional constraints, for example, regarding the order and the number of times that certain elements occur in a document. Additional information on rules pertaining to well-formed and valid XML documents is provided by the W3C at http://www.w3.org/TR/REC-xml#sec-well-formed.

The preferred embodiments of the invention apply to non-validating parsers as well as to validating parsers. It is noted that each validating parser is a functional superset of a non-validating parser. Thus, in the following description we no longer distinguish the two types, except where explicitly noted.

An overview of the present invention is given here prior to describing the invention in more detail with reference to the accompanying drawings. In one aspect, the invention comprises providing information related to the structure of an XML document to an XML processor/parser. Such information may then be used to speed up processing of the document. Information relating to the structure of the document may include but is not limited to the location and size of tokens, position of start and end tags, etc., as those of skill in the art will recognize.

In another aspect, the invention involves providing information related to processing that may already have been performed on a given XML document by, for example, an XML accelerator or preprocessor. From this information, the XML processor or parser may derive which processing remains to be performed for the given XML document. This information may consist of results of certain well-formedness checks and/or other parsing operations. For example, the preprocessor may indicate that it has checked that all start and end tags are matching and are correctly nested. Another example would be that all entity references have been replaced by the corresponding values. This may include the five “standard” entities, known to those of ordinary skill in the art as &amp, &lt, &gt, &apos and &quot, and also entity references defined in a DTD.

A preprocessor may be used to perform certain functions before it forwards preprocessing information to a parser. Due to resource limitations such as limited memory, however, a preprocessor maybe able to perform a certain function only partially. For example, the preprocessor may check only a subset of all start and end tags. Or, the preprocessor may replace only a subset of the entity references by corresponding values.

To address the situation in which a preprocessor partially performs certain functions before a document is provided to a parser, the invention in a preferred embodiment enables the processing information provided to an XML parser to describe which portions of the XML document have been processed already by certain functions. For example, the invention may provide processing information identifying tags and entity references that have been processed by the XML preprocessor and thus which tags and entity references still need to be processed by the XML parser. This type of processing information may be efficiently combined with structure information described above.

As described in further detail below, a preferred embodiment of the invention addresses: (1) information related to the structure and/or processing of an XML document, wherein this information may be provided to an XML parser to enable faster processing; and (2) embedding such information within an XML document itself, or in an associated document.

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass data, instructions, program code, and/or one or more computer programs, and/or data files accessible from one or more computer usable devices, carriers, or media. As such, the functionality of the embodiments of the invention can be implemented in hardware in a computer system and/or in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for use in a CD ROM) or a floppy disk (for eventual use in a floppy disk drive), or downloaded via the Internet or other computer network, as discussed above. The present invention applies equally regardless of the particular type of signal-bearing media utilized.

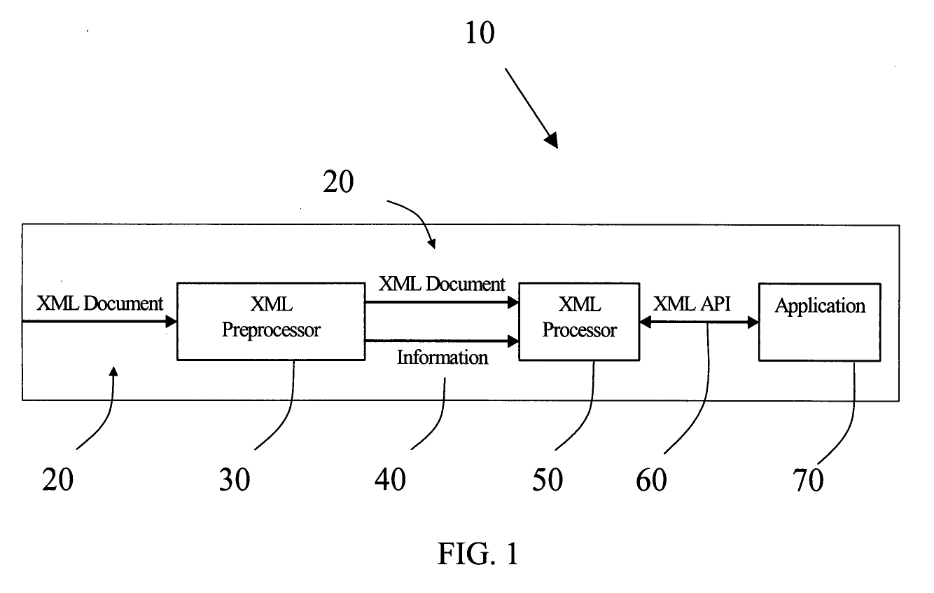

With reference now to FIG. 1, a schematic diagram is shown which illustrates an architecture of a parsing system 10 in which a preferred embodiment of the present invention may be implemented. Parsing system 10 may be used to parse XML document 20. A hardware-based preprocessor 30 extracts information from XML document 20 pertaining to the document structure and possibly other meta-information and/or performs a subset of the XML parsing/processing operation. The preprocessor 30 is preferably implemented, so far as possible, in hardware, although it could still be implemented or at least partially implemented in software, where appropriate or desired.

According to the method of the invention, information 40 about the document structure and/or processing may be represented and associated with the XML document 20 and passed to XML processor 50. XML processor 50 is preferably a software-based XML parser that parses the XML document and achieves a performance advantage by using information about the document structure for the parsing and/or information related to the processing already performed by the XML preprocessor. The preferred architecture illustrated in FIG. 1 also indicates that an application programming interface (API) 60, such as standardized XML processing APIs, may be used by an application 70 to access the content of the XML document 20.

Application 70 preferably uses the standardized XML processing APIs (such as the SAX1, SAX2, DOM1, DOM2, DOM3 API) to access the contents of document 20. These standardized APIs do not need to be changed in order to enable an application 70 to access the content of an XML document 20 when a preferred embodiment of the invention is implemented.

According to the preferred embodiment, an XML parser may be split into two parts: a “low-level” part 30 that preferably implemented in hardware but may also be implemented in software and a “high-level” part 50 that is implemented in software. The “low-level” part 30 is referred to as an XML preprocessor in FIG. 1 and may also be described as an accelerator. An example of an accelerator implementation is described in patent application Ser. No. 10/970,798, “PATTERN-MATCHING SYSTEM,” by Jan Van Lunteren, filed in the United States Patent Office on Oct. 21, 2004 (claiming priority to European Patent Office Patent Application Serial No. EP 03405884.2, filed Dec. 10, 2003). Advantageously, the “high-level” part 50 is capable of offering the same XML processing APIs as today's standard XML parsers; due to hardware assists, however, it parses XML documents at much higher speeds.

We now discuss the contents of the document structure and how this information may be associated with the original document 20. A similar discussion for processing-related information will be provided afterwards.

### Document Structure Information

Information about the document structure is preferably represented and associated with the original XML document such that:

the original XML document still conforms to the XML standard;

the original XML document can be processed with any XML parser/processor;

the result of processing an XML document that is structure-enriched (as discussed in further detail below) is the same as that of processing the original XML document;

a parser that is able to process structural information is able to retrieve this information such that parsing is accelerated.

The method of the invention represents information 40 about the structure and/or processing of document 20 and associates such information with the document 20, thereby enabling processing at XML processor 50 to be done quickly and efficiently. In particular, the contents of the document structure, when represented and associated with the document in accordance with the preferred embodiment, have effects on the parser as described in Table 1 and as described in further detail below:

TABLE 1
Structural Content and Effect on XML Processor

| | Effect on XML Software |
|---|---|
| Contents of document structure | Processor/Parser |
| Position of start element tags, | The parser no longer needs to |
| length of tags and position of | identify the tags and check |
| corresponding end element tags | whether each start tag has |
| and its length. | a corresponding end tag. |
| For each element: number, position | The attribute content becomes |
| and length of the attributes and | directly accessibly be the parser. |
| position and length of the | |
| attribute's name. | |
| Optional: for each element tag | The parser no longer needs to |
| or attribute name (for each | build up the token table itself. |
| terminal symbol), a binary | |
| representation of that symbol. | |
| This information is the “token table” | |
| of the XML document. | |

According to alternative embodiments of the invention, structural information may be included within an XML document or it may be represented as an external document. The first alternative is called “inline representation,” and the latter is called “external representation,” both of which are discussed in further detail as follows.

Inline Representation

According to embodiments of the invention associated with inline representation, structural information may be included in an XML document as XML comments or as XML processing instructions. The structural information may be located at the beginning or end of an XML document or scattered throughout the document, describing the XML element that immediately follows. While the exact format of this structural information is not critical to the invention, a format preferably fulfils the following properties for inline representation:

the format should be “machine friendly”, i.e. a parser should be able to very quickly access the content.

the format should not violate the XML specification, i.e. binary format is not permissible.

the format should contain position information that preferably omits comments.

The reason is for this preference is that comments are typically filtered out before the actual parsing begins.

Structural information as comments: According to one embodiment of the invention, structural information about a document is provided in the form of comments. XML comments that contain structure information are marked with a tag, for example “@S”. If, by any chance, this mark is already part of an existing XML comment, then the false mark will be changed by adding another “@”. This is a well-known technique called “escaping”. An non-limiting example of a structure-enriched document is given below:

<?xml version =“1.0”?>
<!-- comment A -->
<!--
@S
BE:L1;P0;L2;P1;T1:“xdoc”
EE:L4;P0;L5;P0
-->
<xdoc>
<!--
@S
BE:L2;P1;L2;P11;T2:“greeting”
EE:L2;P21;L3;P1
-->

<greeting>Hello XML!</greeting>
<!-- comment B -->
<hallo><morgen></morgen></hallo>

</xdoc>

The meaning of, for example, BE:L2; P1;L2; P11;T2: “greeting” is: “begin element” tag exists at line 2; position until line 2; position 11; the tag gets token number 2 and the tag has the name “greeting”.

Structural information as XML processing instructions: An alternative embodiment of the invention uses XML processing instructions to represent structural information within the XML document. As XML processing instructions are not part of the XML content, any format (based on unicode characters) may be used. The following is an example of a structure-enriched document based on XML processing instructions:

<?xml version =“1.0”?>
<!-- comment A -->
<?structInfo BE:L1;P0;L2;P1;T1:“xdoc” EE:L4;P0;L5;P0 ?>
<xdoc>
<?structInfo BE:L2;P1;L2;P11;T2:“greeting”
EE:L2;P21;L3;P1 ?>

<greeting>Hello XML!</greeting>
<!-- comment B -->
<hallo><morgen></morgen></hallo>

</xdoc>

In this non-limiting example, the tag structInfo is used to indicate structural information.

Those of skill in the art will of course recognize that many other variations of structural information in the form of comments or as processing instructions may be used without departing from the spirit and scope of the invention or equivalents thereof.

External Representation

Structural information that is represented externally to the XML document (“external representation”) may contain essentially the same information as is provided when internal representation is used. Two key differences are noted, however, between these methods of representing structural information. First, the external representation includes a reference to the XML document. This may be an explicit reference such as, for example, a filename or a document ID. Alternatively, the reference may be an implicit reference: for example, both the XML document and the external structure information may simultaneously be made available to the XML parser. Another key difference between inline and external representation is that the external representation is not bound to the XML specification. That is, the structure information may be encoded in any form that is suitable to the parser, including binary representation. Examples of several embodiments illustrating external representation follow.

External Representation: As an External File

In the case where a filesystem is available, the external information that represents structural information of a document may be stored in a separate file. The original XML document then contains a reference, preferably in the form of a filename, to the external structural information. The reference may be encoded using either XML comments or XML processing instructions. This approach allows re-use of the same structural information for multiple XML documents that have the same structure.

The structural information may be represented in any form, i.e. the encoding may be unicode characters or some binary representation. Also, the content may be structured as a sequence of matching tags or as a tree representation. An example is given below:

The example XML document:

<?xml version =“1.0”?>
<!-- comment A -->
<?structInfo reference=file://struct.info?>
<xdoc>

<greeting>Hello XML!</greeting>
<!-- comment B -->
<hallo><morgen></morgen></hallo>

</xdoc>

The example structural information document (in filename struct.info):

BE:L1;P0;L2;P1;T1:“xdoc”

EE:L4;P0;L5;P0

BE:L2;P1;L2;P11;T2: “greeting”

EE:L2;P21;L3;P1

As demonstrated in the above example, the XML document contains a reference to filename struct.info, an external document containing structural information about the XML document.

External Representation: As Part of a Protocol Header

Structural information may also be encoded as part of a protocol header; for instance as an extension header to a protocol such as IP, TCP, UDP or HTTP. Whereas the encoding details differ from protocol to protocol, the principle remains the same, independent of the protocol. As an example, the use of an extension header in an HTTP protocol data unit (PDU) is shown below:

HTTP/1.1 200 OK
Content-Type: text/xml; charset=utf-8
XML-StructInfo: BE:L1;P0;L2;P1;T1:“xdoc”
XML-StructInfo: EE:L4;P0;L5;P0
XML-StructInfo: BE:L2;P1;L2;P11;T2:“greeting”
XML-StructInfo: EE:L2;P21;L3;P1
Content-Length: length
<?xml version =“1.0”?>
<!-- comment A -->
<xdoc>

<greeting>Hello XML!</greeting>
<!-- comment B -->
<hallo><morgen></morgen></hallo>

</xdoc>

In this example, an additional header-tag “XML-StructInfo” has been introduced. It is used to separate the structural information from the XML content.

External Representation: In Special Purpose Hardware Registers

Hardware registers are typically limited in their capacity, but otherwise they can be treated similarly to the other methods of storing structural information. According to an embodiment of the invention wherein external representation is accomplished through the use of hardware registers, the original XML document contains a reference to the register or registers where structural information is contained. In some embodiments, there will only be one set of registers and then it is sufficient to indicate that structural information is present in hardware registers.

External Representation: In a Dedicated Memory Segment

Storing structural information in a dedicated memory segment is similar to storing structural information in a separate file. In an embodiment wherein a dedicated memory segment is used, the original XML document contains a reference to the memory location that contains the structural information.

### Document (Pre)Processing Information

As noted above with respect to FIG. 1, the preprocessor 30 may perform processing on XML document 20 and may provide information 40 indicating the processing that has already been performed. This information 40, and consequently, the processing that has to be performed by the parser/processor 50, may be included in the XML document 20 (see “inline representation,” above) or represented externally in the same manner as with the structural information as described above (see “external representation”). A number of examples have already been given to illustrate the concepts of inline representation and external representation. An example is given here to illustrate how processing-related information 40 may be provided to a parser in accordance with one embodiment of the invention. The example below illustrates this concept using an inline representation based on XML comments to indicate the processing that has already been performed. The application of other inline and external approaches will be readily apparent to persons skilled in the art based on the descriptions given above.

The following non-limiting example comprises the original example of including structural information in the XML document using comments, extended with some processing information related to the processing of element tags.

<?xml version =“1.0”?>
<!-- comment A -->
<!--
@S
BE:L1;P0;L2;P1;T1:“xdoc”
EE:L4;P0;L5;P0
@P
EC: B,M,L,U
-->
<xdoc>
<!--
@S
BE:L2;P1;L2;P11;T2:“greeting”
EE:L2;P21;L3;P1
-->

<greeting>Hello XML!</greeting>
<!-- comment B -->
<hallo><morgen></morgen></hallo>

</xdoc>

In this example, the processing related information is added after a tag “@P”. Within the expression “EC: B, M, L, U”, EC stands for Element Check information, and B indicates that all elements have been checked to be balanced (“nested”) correctly, M indicates that for all elements the start and end tags have found to be matching, L indicates that all element names have been checked to consist of legal characters, and U indicates that all attributes corresponding to each element (if existing) have unique names.

In a similar way, information can be added that only relates to a certain component of the XML document, for example, an element or attribute.

Preprocessing performed by preprocessor 30 may comprise incomplete or partial processing of the XML document or of parts of the XML document. For example, if the XML document resides in TCP packets, the preprocessing may comprise obtaining incomplete or partial information pertaining to the structure of the XML document. The partial information could include, for example, the location of symbols (such as <, >), white space, or other structural information that can be used to accelerate the subsequent processing (at processor 50) of the entire XML document that is composed from those parts. Once the XML document is reassembled from the TCP packets, the structure information related to the individual parts may also be combined or merged.

Processing-related information as provided according to the method of the invention enables faster, more efficient processing. The functions that are performed by the preprocessor 30 may be included in the processing-related information 40 and affect the XML processor 50, as the examples of Table 2 describe:

TABLE 2
Processing-Related Information and Effect on XML Processor

| Functions Performed | Effect on XML Software |
|---|---|
| by Preprocessor | Processor/Parser |
| For entire XML document: | The parser no longer |
| one single root element exists | needs to perform the |
| all start/end tags checked to be | corresponding operations |
| matching and to be nested correctly | for the entire document. |
| all names (elements, attributes) | |
| are checked to contain legal characters | |
| for each element, all attributes | |
| are checked to have unique names | |
| above checks have been performed | |
| for all name spaces | |
| all entity references have been resolved | |
| etc. (for example, see XML specification | |
| for list of other well-formedness checks) | |
| For each element (if corresponding | The parser no longer |
| function has not been performed for | needs to perform the |
| entire document): | corresponding operations |
| start and end tags have been checked for | for the given element. |
| matching and correct nesting | |
| element name contains legal characters | |
| all attribute names contain | |
| legal characters | |
| all attribute names are unique | |

It is to be appreciated that the term “processor” as used herein is intended to include any processing device, such as, for example, one that includes a CPU (central processing unit). The term “memory” as used herein is intended to include memory associated with a processor or CPU, such as, for example, RAM, ROM, a fixed memory device (e.g., hard drive), a removable memory device (e.g., diskette), etc. It is also to be understood that various elements associated with a processor may be shared by other processors. Accordingly, software components including instructions or code for performing the methodologies of the invention, as described herein, may be stored in one or more of the associated memory devices (e.g., ROM, fixed or removable memory) and, when ready to be utilized, loaded in part or in whole (e.g., into RAM) and executed by a CPU.

The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. A series of computer readable instructions embodies all or part of the functionality previously described herein.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and data video disk (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also coupled to the system to enable the data processing system to become coupled to other data processing systems or remote printers or storage devices through intervening private or public networks. Modems, cable modem and Ethernet cards are just a few of the currently available types of network adapters.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention or equivalents thereof.

1. A computer-implemented method for processing an XML document, comprising:
providing, to a processor, information relating to the structure of the XML document; and
providing, to the processor, information obtained by preprocessing the XML document.

2. A method according to claim 1, wherein the information relating to the structure of the XML document is associated with the XML document.

3. A method according to claim 1, wherein the information relating to the structure of the XML document is embedded in the XML document as a comment.

4. A method according to claim 1, wherein the information relating to the structure of the XML document is comprised of processing instructions.

5. A method according to claim 1, wherein the information relating to the structure of the XML document comprises at least one offset of at least one element in the XML document.

6. A method according to claim 2, wherein the information relating to the structure of the XML document is included in an external file.

7. A method according to claim 6, wherein the external file is a second XML document.

8. A method according to claim 2, wherein information relating to the structure of the XML document is included in a protocol header of a protocol data unit.

9. A method according to claim 2, wherein the information relating to the structure of the XML document is retrieved from a memory segment.

10. A method according to claim 2, wherein the information relating to the structure of the XML document is retrieved from a hardware register.

11. A method according to claim 1, wherein the information obtained by preprocessing the XML document comprises information indicating processing and corresponding results that have been performed for at least one element in the XML document.

12. A method according to claim 1, wherein the information relating to the structure of the XML document comprises the number of times a first element in the XML document occurs as a child of a second element in the XML document.

13. A method according to claim 1, wherein the information relating to the structure of the XML document comprises a type description of at least one element in the XML document.

14. A method according to claim 1, wherein the information relating to the structure of the XML document comprises a token table.

15. A computer-implemented method for processing an XML document, comprising:
providing, to a parser, information relating to the structure of the XML document; and
providing, to the parser, information pertaining to partial processing of the XML document in response to preprocessing a portion of the XML document by a preprocessor.

16. A method according to claim 15, wherein the preprocessing is adapted to process one or more portions of an XML document residing in a transmission control protocol (TCP) packet.

17. An apparatus for processing an XML document, the apparatus comprising:
a preprocessor unit for extracting at least a portion of information provided by the XML document; and
a processor unit for parsing the XML document in response to preprocessing performed by the preprocessor.

18. A computer program device readable by a machine, tangibly embodying a program of instructions executable by a machine to perform method steps for processing an XML document, said method comprising:
providing, to a processor, information relating to the structure of the XML document; and
providing, to the processor, information obtained by preprocessing the XML document.
